(19) United States
(12) Patent Application Publication
(10) Pub. No.: US 2026/0307351 A1
(43) Pub. Date: Oct. 8, 2026

(54) TIRE CURING PRESS AND METHOD FOR PRODUCING TIRES

(71) Applicant: HARBURG-FREUDENBERGER MASCHINENBAU GMBH, Hamburg (DE)

(72) Inventors: Stefan BAHLKE, Lüneburg (DE); Maximilian BEVERBURG, Hamburg (DE)

(21) Appl. No.: 19/482,376

(22) PCT Filed: Mar. 25, 2024
(86) PCT No.: PCT/DE2024/100255

§ 371 Date: Nov. 7, 2025

(30) Foreign Application Priority Data
May 8, 2023 (DE) 10 2023 111 983.4

(51) Int. Cl. B29D 30/06

(52) U.S. Cl. CPC B29D 30/0603

(57) ABSTRACT

A tire curing press comprising at least one loading and/or unloading device and a method for producing tires. A separate column for the loading and/or unloading device is dispensed with and this is arranged on the upper part of the tire curing press, on the guide column of a tire curing press designed as a column press, or on the drive unit.

The invention relates to a tire curing press with at least one loading and/or unloading device.

In addition, the invention relates to a method for producing tires with a tire curing press.

According to known designs of tire curing presses with at least one loading and/or unloading device, these are usually mounted on a separate column which is arranged in the area of the tire curing press, usually in front of or behind it.

These stationary loading and/or unloading devices usually have a lifting drive with a position measuring system, a swivel mechanism, a stationary column as a vertical guide, which is fixed to the hall floor or the press base, and a receiving device for receiving and holding the green tires or tires to be loaded or unloaded.

In addition to the cost of a separate column for a loading and/or unloading device, the space required for the installation and fastening of the separate column is also a disadvantage. On the one hand, the space required for the tire curing press with such a loading and/or unloading device is correspondingly large, and on the other hand, the usable working area around the tire curing press is also reduced. This is particularly inconvenient during maintenance or repair work or when inserting, changing, or removing the molds from the cavity.

It is therefore an object of the invention to create a tire curing press that at least partially remedies these disadvantages.

This object is achieved by a tire curing press according to patent claim 1.

A further object of the invention is to provide an improved method for producing tires.

This object is achieved by a method for producing tires according to patent claim 11.

In the dependent patent claims advantageous embodiments of the invention are claimed.

The features of a tire curing press and a method for producing tires disclosed below are part of the invention in all practicable combinations.

A tire curing press according to the invention has at least one cavity, also known as a vulcanization chamber, and is divided into a lower part of the press and an upper part of the press, wherein the upper part of the press can be moved vertically relative to the lower part of the press to open and close the at least one cavity.

Furthermore, a tire curing press according to the invention has at least one loading and/or unloading device, wherein at least one loading and/or unloading device is arranged on the upper part of the press.

In other embodiments of the invention, the at least one loading and/or unloading device is arranged on at least one guide column of a tire curing press designed as a column press or on at least one drive device of the tire curing press.

The loading and/or unloading device has at least one slewing drive and at least one receiving device for receiving and holding the green tires or tires to be loaded or unloaded, which is designed, for example, as a fork and/or a gripper.

In the corresponding embodiments of the invention, the at least one loading and/or unloading device is arranged on the upper part of the press in such a way that it can be moved together with the upper part of the press.

The loading and/or unloading device also has at least one lifting device with which the at least one receiving device can be moved in the vertical direction. The position of the at least one receiving device is thus variable in relation to the upper part of the press.

This allows the at least one receiving device of the loading and/or unloading device to be moved into the position required for the process step being carried out with the tire curing press at the respective point in time. If this movability of the receiving device were not available in embodiments with a loading and/or unloading device mounted on the upper part of the press, it would have to be permanently positioned at the height required for loading and/or unloading the tire curing press below the upper part of the press. When the tire curing press is closed, the corresponding space next to the lower part of the press would have to be kept free. In addition, due to the high total weight, the precise positioning of the upper part of the press is much more complex than simply moving the receiving device to the required height.

In preferred embodiments of the invention, the loading and/or unloading device has at least one linear guide element for guiding the at least one receiving device during vertical movement with the aid of the at least one lifting device.

In embodiments of the invention, the slewing drive of the at least one loading and/or unloading device has at least one linear drive, at least one converter for converting the linear movement of the linear drive into a rotary movement, and at least one rotatable axis.

With the aid of the linear drive, a drive element can be moved back and forth on a linear axis of movement.

In preferred embodiments of the invention, the linear drive of the slewing drive is arranged such that the linear axis of movement of the linear drive and the axis of rotation of the slewing drive are approximately parallel or identical.

In advantageous embodiments of the invention, the linear drive of the slewing drive is arranged in such a way that the linear axis of movement of the linear drive is aligned approximately vertically. The corresponding arrangement of the linear drive enables a particularly space-saving design of the slewing drive in terms of the area required in top view.

In preferred embodiments of the invention, the converter for converting the linear movement of the linear drive into a rotary movement has at least one guide and at least one sliding element guided in the guide.

The guide is designed to accommodate the sliding element and, in embodiments of the invention, is shaped at least in some areas in a spiral or helical manner.

In embodiments of the invention, the guide is designed as a groove or a slot in a guide body.

In embodiments of the invention, the guide body is cylindrical or tubular.

In embodiments of the invention, the sliding element is designed as a pin, for example with a cylindrical body. In embodiments of the invention, the sliding element is designed as a roller pin and/or provided with a mushroom head.

In various embodiments of the invention, one of the elements, namely the guide or guide body or sliding element, is fixedly connected to the drive element of the linear drive at least in the direction of the linear axis of movement. The other element is mounted so that it can rotate relative to the element connected to the linear drive in such a way that it can be set in rotational motion about the axis of rotation of the slewing drive by the linear movement of the drive element of the linear drive and by the guide of the sliding element in the guide.

In preferred embodiments of the invention, the slewing drive has at least one pivot bearing, for example designed as a roller bearing, for the rotatable mounting of the respective rotatable element.

Furthermore, embodiments of the invention are conceivable in which the drive element of the linear drive is rotatable and/or has a rotatable area.

In embodiments of the invention, the rotatable element is fixedly connected to a rotatable axle which serves to connect the slewing drive to the assembly of a loading and/or unloading device to be swiveled.

In the corresponding embodiments of the invention, the guide in the guide body has a first and a second end and runs in the direction of the axis of rotation of the slewing drive from the first end to the second end in or on the guide body.

In a sectional plane perpendicular to the axis of rotation, the angle between the first and second ends of the guide defines the maximum angle of rotation of the slewing drive.

With constant/uniform movement of the drive element of the linear drive, the change in angle defined by the guide as a function of the distance traveled by the drive element defines the rotational speed of the slewing drive.

Areas with a small change in angle as a function of the distance traveled can thus be used to incorporate slow elements into the rotational movement.

In preferred embodiments of the invention, the guide has a linear section or a section with a small change in angle as a function of the distance traveled in at least one of the end sections. This allows a motion profile to be achieved that eliminates the need for shock absorbers.

For example, motion profiles with two or more stopping points can be achieved, in which the guide is linear in the direction of the axis of rotation.

In preferred embodiments of the invention, the guide has two corresponding guides realized opposite each other on or in the guide body, in each of which a sliding element is guided. This ensures lower forces acting on a single sliding element and thus reduces wear.

In preferred embodiments of the invention, the converter is at least partially arranged in a housing. In embodiments of the invention, the housing covers the guide or encloses the guide body and/or the sliding element in such a way that they are protected against the ingress of dirt and dust and/or that, for safety reasons, it is not possible for people to reach inside.

In preferred embodiments of the invention, the slewing drive has at least one linear guide that ensures linear movement of at least one sliding element on a linear axis of movement.

In embodiments of the invention, the at least one sliding element engages both the at least one guide and the at least one linear guide. Either the linear guide or the guide is fixed and immovable, so that the rotatable element provided with the other guide element can be forced to rotate.

In embodiments of the invention, the straight guide is implemented with the aid of the linear drive. For example, the shaft of the drive element is designed to be rotationally secure in the direction of the axis of rotation, corresponding to a corresponding opening in the linear drive through which the shaft of the drive element passes. In embodiments of the invention, this can be achieved, for example, by means of an at least angular shape of the corresponding opening and the shaft cross-section.

In embodiments of a tire curing press according to the invention, this is designed as a column press and has at least one column.

In embodiments of the invention, the at least one column is designed as a fixed column. Compared to swiveling or retractable columns, fixed columns allow the tire curing press to take up less space, so that during operation of the tire curing press, no space needs to be reserved in front of or behind the tire curing press for swiveling the upper part of the press to open it, or below the tire curing press for retracting the columns.

In embodiments of the invention, fixed columns are not pivotable or retractable, but are stationary and immovable in all functional states of the assembled tire curing press.

In embodiments of the invention, the tire curing press has exactly two columns.

In embodiments of the invention, the at least one column is designed to guide the upper part of the press.

In embodiments of the invention, the at least one column is arranged vertically in its longitudinal direction.

In embodiments of the invention, the at least one column is designed as a round guide.

In embodiments of the invention, the at least one column is firmly connected to the lower part of the press and the upper part of the press is guided in its movement along the column. Preferably, the at least one column is designed as a fixed column in these embodiments of the invention.

In other embodiments of the invention, the at least one column is firmly connected to the upper part of the press and guided in the area of the lower part of the press. In such embodiments of the invention, the at least one column is preferably retractable into a floor on which the tire curing press is set up.

The tire curing press according to the invention has at least one drive unit for moving the upper part of the press relative to the lower part of the press.

In embodiments of the invention, the at least one drive unit can be operated electrically and/or hydraulically.

In embodiments of the invention, at least one drive unit is implemented as a cylinder, in particular as a hydraulic cylinder.

However, embodiments with other drive units are also conceivable. It is important that these are suitable for lifting the weight of the upper part of the press in a vertical direction or lowering it in a controlled manner.

In embodiments of the invention with one drive unit and at least two columns, the drive unit is preferably arranged centrally between two of the columns.

In embodiments of the invention, at least two of the columns are assigned a separate drive unit and arranged in the area of the respective column.

In embodiments of the invention, the assigned drive unit is arranged close to the respective column.

In other embodiments of the invention, a drive unit is integrated into at least one of the columns.

In an advantageous embodiment of the invention with at least one cylinder as a drive unit, this is arranged so that the force is transferred directly into the floor on which the tire curing press is set up.

In embodiments of the invention, the tire curing press is designed as a double tire curing press having two cavities for vulcanizing tires.

In a tire curing press designed as a double heating press with cavities arranged side by side, the parts of the adjacent cavities arranged on the upper part of the press are mechanically connected to each other in preferred embodiments of the invention so that they can be moved together.

The mechanical connection of the cavities to each other enables the two cavities to be moved together in embodiments of the invention. This means that the cavities can be controlled synchronously for the vulcanization process, in particular for opening and closing the cavities.

In preferred embodiments of the invention, the adjacent cavities are arranged very close to each other. This enables a particularly narrow width of the tire curing press. Preferably, the adjacent parts of the cavities in the upper part of the press are arranged so close to each other that they just do not touch.

In embodiments of the invention, all columns are arranged between the lateral ends of the at least one cavity facing away from each other, so that the width of the tire curing press is defined by the at least one cavity.

In embodiments of the invention, all columns are arranged completely within the area defined by the smallest rectangle enclosing the at least one cavity in a top view. This means that the width and depth of the tire curing press are defined by the width and depth of the at least one cavity and are not increased by columns standing outside the at least one cavity.

The press upper part has at least part of the at least one cavity and at least one connecting element for connecting the press upper part to the drive unit and for guiding the press upper part along the at least one guide column.

In preferred embodiments of the invention, the upper part of the press has a hood-like component of the cavity. It is particularly preferred that the hood-like component of the cavity is designed as an insulating hood, so that a thermally insulated vulcanization chamber is realized.

The at least one connecting element is preferably designed as a stable supporting structure, for example made of steel, which provides a point of attachment for the at least one drive unit on the upper part of the press and to which the parts of the at least one cavity arranged on the upper part of the press are attached. In advantageous embodiments of the invention, at least one guide element guiding the upper part of the press along the at least one guide column is also part of the connecting element.

In preferred embodiments of the invention, the at least one connecting element is arranged directly in the area of the at least one guide column.

In embodiments of the invention, the press upper part has at least one connecting element per guide column.

In advantageous embodiments, the press upper part has at least one laterally arranged and vertically aligned mounting surface to which a loading and/or unloading device can be attached.

In preferred embodiments, the at least one mounting surface is provided on at least one connecting element.

In preferred embodiments of the invention, the at least one loading and/or unloading device is connected to the press upper part at the at least one mounting surface provided on the press upper part.

If the mounting surface is provided as part of the supporting structure or the connecting element, a stable and secure connection of the at least one loading and/or unloading device to the upper part of the press is enabled.

If the mounting surface(s) is/are also provided close to the at least one guide column, a weight distribution on the upper part of the press that is advantageous for the safe and stable movement of the upper part of the press is also achieved.

In advantageous embodiments of the invention with at least one cylinder as the drive unit, the upper part of the tire curing press has at least one extension connected to the at least one cavity and protruding upward beyond it, which enables the tire curing press to be set up at ground level while providing the stroke required to fully open the at least one cavity. The point of attachment of the at least one cylinder on the upper part of the press is set so far upward with the aid of the extension that the required stroke can be achieved.

In embodiments of the invention, the at least one loading and/or unloading device is arranged on an extension at the head of the tire curing press. Preferably, in corresponding embodiments, the linear guide and/or the stroke drive of the loading and/or unloading device is mounted on the extension.

It is particularly preferred that the extension is part of the connecting element or part of the stable supporting structure of the upper part of the press.

A method according to the invention for manufacturing tires using a tire curing press comprising a press upper part and a press lower part comprises at least the following process steps:
opening the tire curing press by moving the press upper part relative to the press lower part,
moving at least one receiving device of at least one loading and/or unloading device to the height of the loading or unloading position,
swiveling the receiving device into the cavity of the tire curing press,
picking up a vulcanized tire from the cavity or placing a green tire in the cavity,
swiveling out of the cavity.

When loading the tire curing press, in embodiments of the method according to the invention, the receiving device is first moved to a receiving position for receiving a green tire from a receiving station.

After loading the cavity, the tire curing press is closed and at least one green tire is vulcanized in the at least one cavity.

When unloading the tire curing press, in embodiments of the method according to the invention, the receiving device is moved to a storage position for storing the tire on a storage station after the vulcanized tire has been removed from the cavity of the tire curing press and swung out of the cavity.

In various embodiments of the invention, at least one separate loading device and unloading device or at least one loading and unloading device can be used to load and unload the tire curing press.

In advantageous embodiments of the method according to the invention, in which a tire curing press with at least one loading and/or unloading device connected to the upper part of the press is used, the following method sequence is implemented, whereby the description can be extended accordingly to tire curing presses with more than one cavity:
In a first step, the tire curing press is opened and the receiving device of the at least one loading and/or unloading device is moved to the waiting position in terms of its height.
In a second step, the tire curing press is closed onto the lower part of the press by means of the upper part of the press.

Following step two or in parallel with it, the receiving device of the at least one loading and/or unloading device is moved to the receiving position in the area of a receiving station. As a rule, the receiving device is moved downwards for this purpose.

In the receiving position, a green tire is picked up using the receiving device.

The tire curing press is then opened by moving the upper part of the press away from the lower part of the press, and the receiving device of the at least one loading and/or unloading device is moved to the loading position in terms of its height. Depending on the dimensions of the heating press, the stroke for opening the tire curing press, and the height of the receiving position, the loading position is reached either by moving the upper part of the press alone or by additionally moving the receiving device. As a rule, the receiving device is moved further downwards in relation to the upper part of the press.

Then the receiving device of the at least one loading and/or unloading device is swung into the cavity and the tire curing press is loaded with the green tire.

After the green tire has been placed in the cavity, the receiving device is swung out of the cavity. Depending on the tool used by the receiving device to hold the green tire, it may be necessary to lift the receiving device into a swing-out position beforehand. The tire curing press is then closed by moving the upper part of the press relative to the lower part of the press.

If a loading and unloading device is used, the receiving device must remain free and is moved to a waiting position.

If separate loading and unloading devices are used, the loading device can already be moved back to the receiving position at this point to pick up the next green tire. In other embodiments of the invention, the receiving device is nevertheless moved to a waiting position.

To reach the waiting position, the receiving device is usually moved upwards.

After the tire curing press is closed, the green tire is vulcanized in the cavity of the tire curing press.

The tire curing press is then opened again and the vulcanized tire is moved to the unloading position by moving the receiving device of the at least one loading and/or unloading device in relation to its height.

The receiving device of the at least one loading and/or unloading device is then swung into the cavity and the vulcanized tire is picked up.

The pickup device of the at least one loading and/or unloading device is swung out of the cavity with the vulcanized tire.

Depending on the positioning of a storage station, the receiving device of the at least one loading and/or unloading device is moved to the storage position in terms of its height and the tire is placed on the storage station.

In embodiments of the invention, the vulcanized tire is transferred to a post-treatment device.

In preferred embodiments of the method according to the invention, in which a tire curing press with at least two cavities is used, a common mode of operation is implemented with regard to the loading and/or unloading of the cavities in such a way that the at least two cavities are loaded and unloaded synchronously.

This can be achieved by means of a loading and/or unloading device with at least two receiving devices or by means of at least two separate loading and/or unloading devices.

In embodiments of the invention for manufacturing tires, a tire curing press according to the invention is used.

The figures below illustrate an exemplary embodiment of the invention. They show:

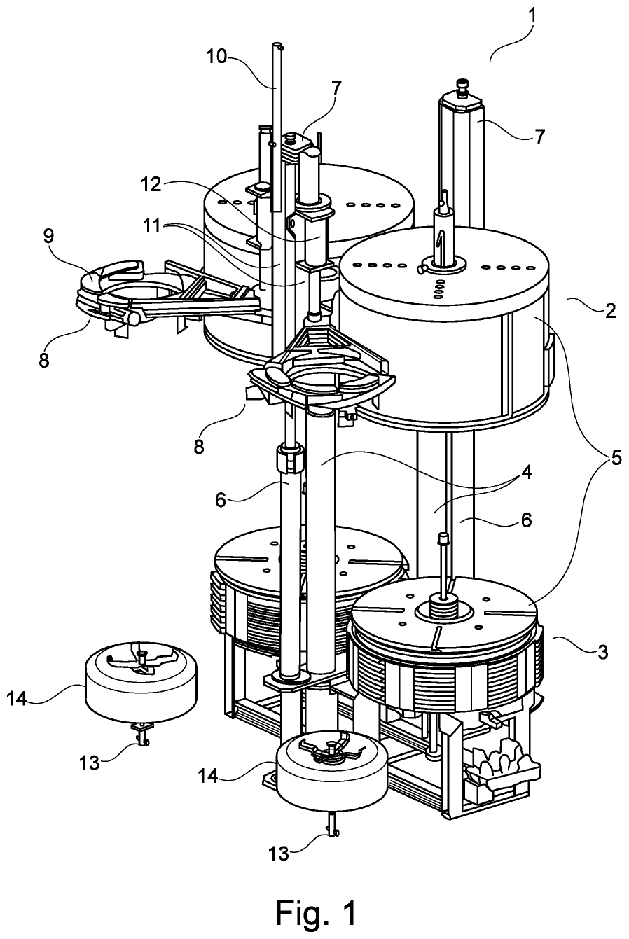

FIG. 1: A perspective view of a tire curing press according to the invention with two cavities arranged next to each other in an open state,

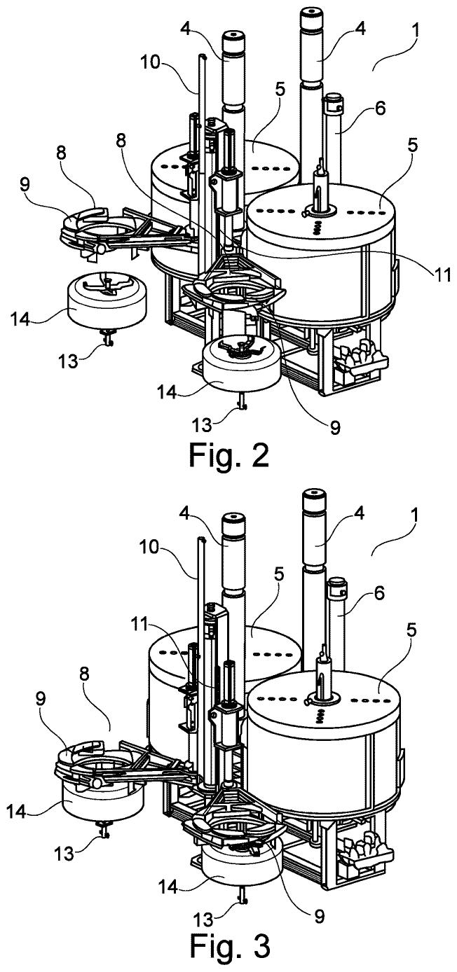

FIG. 2: The tire curing press shown in FIG. 1 in a closed state,

FIG. 3: The tire curing press shown in FIGS. 1 and 2 with the loading and/or unloading device receiving elements moved downward to receive the green tires.

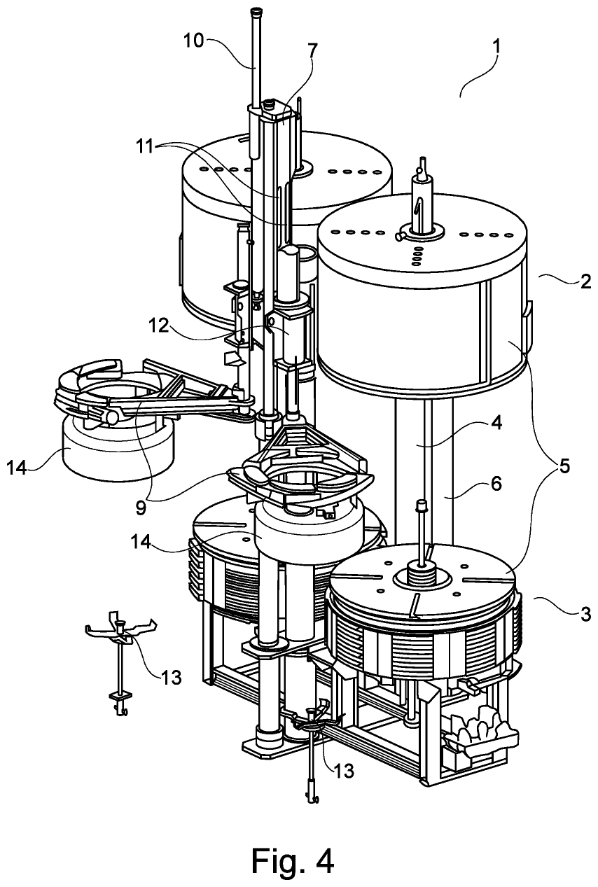

FIG. 4: The tire curing press opened for loading with the loading and/or unloading devices moved to loading height, and

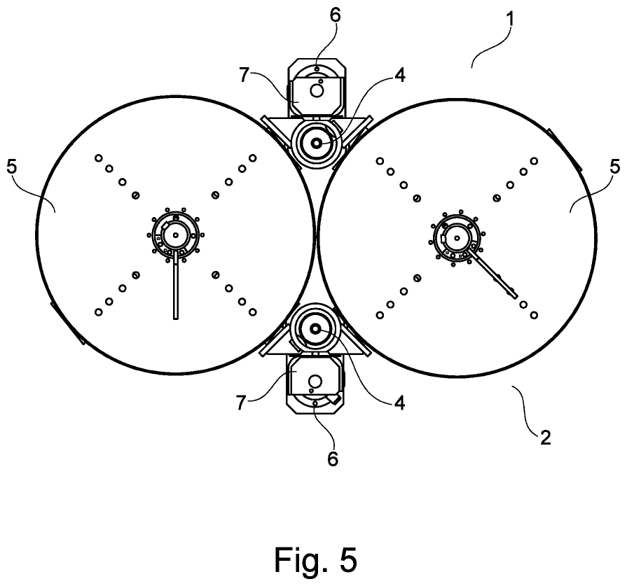

FIG. 5: A top view of the tire curing press without showing the loading and/or unloading device.

FIG. 1 shows an embodiment of a tire curing press (1) according to the invention with an upper part (2) of the press and a lower part (3) of the press in an open state. The tire curing press (1) is designed as a column press with two columns (4) arranged between two cavities (5).

The drive unit (6) is implemented by two cylinders, each of which is arranged on the outside next to one of the columns (4). With the aid of the drive unit (6), the upper part of the press (2) can be moved in a vertical direction to open and close the tire curing press (1). In the embodiment shown, the cylinders are extended for this purpose.

For this purpose, the drive unit (6) is attached to the upper part of the press (2) by means of connecting elements (7). The connecting elements (7) have extensions that protrude upward beyond the cavities (5) in order to enable the required stroke of the upper part (2) of the press when the tire curing press (1) is installed at ground level.

In addition, the tire curing press (1) has two loading and/or unloading devices (8) that are attached to the upper part (2) of the press.

The loading and/or unloading devices (8) are each assigned to a cavity (5) and each have a receiving device (9) and a common lifting device (10).

With the aid of the lifting device (10), the receiving devices (9), in this case designed as gripper and fork combinations, can be moved along the respective linear guide (11) in a vertical direction relative to the upper part of the press (2).

The linear guides (11) and the lifting device (10) are arranged on the extension of the connecting element (7).

In addition, the loading and/or unloading devices (8) each have a slewing drive (12) with which the receiving devices (9) can be swiveled about a vertical axis of rotation.

Two receiving stations (13) are arranged in the lower area in front of the tire curing press (1), on each of which a green tire (14) is held.

The drive device (6), the columns (4), and the lower part of the press (3) are firmly connected to each other via a frame construction.

According to FIG. 2, the tire curing press (1) is closed by retracting the drive device (6). The receiving devices (9) are positioned above the green tires (14) lying on the holding stations (13).

According to FIG. 3, the receiving devices (8) are lowered along the linear guide (11) by means of the lifting device (10) to the receiving position for receiving the green tires (14).

FIG. 4 shows the tire curing press (1) after it has been opened from the position shown in FIG. 3 by moving the upper part of the press (2) upwards. In addition, the receiving devices (9) were lowered further with the aid of the lifting device (10) and thus moved into the loading position.

From this position, the cavities (5) of the tire curing press (1) are loaded by swiveling the receiving devices (9) into the cavities (5) and placing the green tires (14) in them. If necessary, the receiving device (9) is lowered further after swiveling and/or raised before swiveling out.

FIG. 5 shows a top view of a tire curing press (1) according to the invention, but without the at least one loading and/or unloading device (8).

The columns (4) are shown, as well as the hood-like parts of the cavities (5) and the connecting elements (7) as components of the upper part (2) of the press.

The connecting elements (7) form the supporting structure of the upper part (2) of the press, with the hoods of the cavities (5) being connected to or suspended from them.

The connecting elements (7) are guided along the columns (4) and also connect the upper part (2) of the press to the drive device (6).

1-14. (canceled)

15. A tire curing press, comprising: at least one cavity; at least one drive unit; a lower part of the press; a upper part of the press, wherein the upper part of the press is movable vertically relative to the lower part of the press by the at least one drive unit to open and close the at least one cavity; and at least one loading and/or unloading device arranged on the upper part of the press.

16. The tire curing press according to claim 15, wherein the at least one loading and/or unloading device includes at least one slewing drive and at least one receiving device for receiving and holding green tires or tires to be loaded or unloaded.

17. The tire curing press according to claim 15, wherein the at least one loading and/or unloading device is arranged on the upper part of the press so as to be movable together with the upper part of the press.

18. The tire curing press according to claim 16, wherein the loading and/or unloading device includes at least one lifting device for moving the at least one receiving device in a vertical direction so that a position of the at least one receiving device is changeable in relation to the upper part of the press.

19. The tire curing press according to claim 18, wherein the loading and/or unloading device includes at least one linear guide element for guiding the at least one receiving device during vertical movement by the at least one lifting device.

20. The tire curing press according to claim 15, wherein the tire curing press is a column press that has at least one column.

21. The tire curing press according to claim 20, wherein the upper part of the press has at least part of the at least one cavity and at least one connecting element that connects the upper part of the press to the drive unit and guides the upper part of the press along the at least one column.

22. The tire curing press according to claim 21, wherein the upper part of the press has at least one laterally arranged and vertically aligned mounting surface to which the at least one loading and/or unloading device is attached.

23. The tire curing press according to claim 22, wherein the at least one mounting surface is arranged on the at least one connecting element.

24. The tire curing press according to claim 21, wherein the at least one connecting element has an extension that protrudes upward beyond the at least one cavity and the at least one loading and/or unloading device is attached to the extension on the upper part of the press.

25. A method for producing tires using a tire curing press according to claim 15, the method comprising the steps of:
opening the tire curing press by moving the upper part of the press relative to the lower part of the press;
moving at least one receiving device of at the least one loading and/or unloading device to a height of a loading or unloading position;
swiveling the receiving device into an open cavity of the tire curing press;
removing a vulcanized tire from the cavity or placing a green tire in the cavity; and
s in wiveling the receiving device out of the cavity.

26. The method for producing tires according to claim 25, including, when loading the tire curing press, first moving the receiving device into a receiving position for receiving a green tire from a receiving station.

27. The method for producing tires according to claim 26, including, after loading the cavity with the green tire, closing the tire curing press and vulcanizing the green tire in the cavity.

28. The method for producing tires according to claim 27, including moving the receiving device to a storage position for storing the tire on a storage station when the tire curing press is unloaded after the vulcanized tire has been removed from the cavity of the tire curing press and swung out of the cavity.
